(19) United States
(12) Patent Application Publication
(10) Pub. No.: US 2014/0292907 A1
(43) Pub. Date: Oct. 2, 2014

(54) RECORDING APPARATUS

(71) Applicant: Seiko Epson Corporation, Tokyo (JP)

(72) Inventor: Satoshi Chiba, Suwa (JP)

(73) Assignee: Seiko Epson Corporation, Tokyo (JP)

(21) Appl. No.: 14/202,710

(22) Filed: Mar. 10, 2014

(30) Foreign Application Priority Data
Mar. 27, 2013 (JP) 2013-067592

(51) Int. Cl. B41J 11/00

(52) U.S. Cl. CPC B41J 11/007
USPC 347/29; 347/104

(57) ABSTRACT

A recording apparatus includes a transport belt including an inner layer and an outer layer containing a hydrophobic material and having a supporting surface on which a recording medium is supported, a charging device for the transport belt, a line head having a nozzle, and at least either a capping unit or a wiping unit in a region opposing the supporting surface of the transport belt. While an ink is ejected onto the recording medium, the distance between the supporting surface and at least either the capping unit or the wiping unit is larger than the distance between the nozzle of the line head and the supporting surface. The charging device electrically charges the outer layer with an AC current with a frequency in the range of 10 Hz to 200 Hz.

Priority is claimed under 35 U.S.C. §119 to Japanese Application No. 2013-067592 filed on Mar. 27, 2013, which is hereby incorporated by reference in its entirety.

### BACKGROUND

1. Technical Field

The present invention relates to a recording apparatus and a recording method in which recording media are transported by electrically charging the transport belt with an AC current.

2. Related Art

Recording apparatuses are used in which recording media are transported by electrically charging the supporting surface of the transport belt on which the recording media are supported. In some of these recording apparatuses, the supporting surface is charged with an AC current to support recording media thereon. Recording apparatuses of this type do not need electrical charging mechanisms for electrically charging recording media and are accordingly easier to downsize than the type in which the transport belt is electrically charged with a DC current for supporting recording media. Also, the layout of the electrical charging member for electrically charging the transport belt can be more freely designed. For example, JP-A-2007-307755 discloses a recording apparatus in which the recording medium is transported with being adsorbed to the supporting surface of the transport belt and thus supported on the transport belt by alternately applying a positive charge and a negative charge to the supporting surface.

To downsize a recording apparatus in which the recording medium is transported on an electrically charged transport belt, a recording head and other members are desirably disposed in a region opposing the supporting surface of the transport belt in the path through which the recording medium is transported on the transport belt (hereinafter refers to as transport path). However, if a recording apparatus having such a structure is downsized, the area of the transport belt covered with the members disposed in the region opposing the transport belt in the transport path, that is, the coverage of the transport belt, is increased. For example, JP-A-2007-190766 discloses a recording apparatus having a structure in which a recording head and a maintenance unit are disposed in the region opposing the supporting surface of the transport belt. Particularly in the case of recording apparatuses including line heads, the recording head tends to be larger than that of serial type that moves reciprocally in the direction intersecting the direction in which the recording medium is transported. Furthermore, since the capping unit tends to become larger according to the size of the recording head, the coverage of the transport belt is increased relative to serial heads. A structure in which the line head is withdrawn from the surface of the transport belt may be a solution to the increase in coverage. However, the recording apparatus having such a structure must be large.

If the coverage is increased, moisture or the like derived from the ink ejected from the recording head is likely to be accumulated around the supporting surface of the transport belt. Recording apparatuses using a transport belt electrically charged with an AC current to support recording media are liable to be affected by moisture. If the humidity around the transport belt is high, moisture reduces electrostatic adsorption, and consequently, the supporting surface of the transport belt may not easily adsorb the recording medium. This is because the moisture causes adjacent opposite charges at the AC charged supporting surface to cancel each other out.

The present inventors have found that if a large area of the supporting surface is covered, or for example, if the coverage is as high as 60% or more, moisture or the like derived from the ink ejected from the recording head is likely to be accumulated around the supporting surface, and that the moisture makes it difficult for the supporting surface to adsorb the recording medium. This means that a higher coverage leads to reduced electrostatic adsorptivity and may cause failure in transporting the recording medium. The term “coverage” mentioned herein refers to the ratio of the area of the members covering the supporting surface in the transport path when viewed downward in a direction perpendicular to the supporting surface (in plan view) to the area of the supporting surface in the transport path.

However, if the coverage is reduced, for example, to less than 60%, to minimize the phenomenon in which the recording medium cannot be easily adsorbed to the supporting surface of the transport belt, the recording apparatus cannot be sufficiently downsized.

Thus, it has been difficult to minimize failure in transporting the recording medium caused by moisture without increasing the size of the recording apparatus.

### SUMMARY

An advantage of some aspects of the invention is that it provides a downsized recording apparatus using a transport belt whose supporting surface is electrically charged with an AC current for transporting a recording medium, and in which the effect of moisture during the transport of the recording medium is reduced to minimize transport failure caused by the moisture.

According to an aspect of the invention, a recording apparatus is provided which includes an endless transport belt including an inner layer and an outer layer containing a hydrophobic material and having a supporting surface on which a recording medium is supported, an AC charging device that electrically charges the supporting surface of the transport belt at a frequency in the range of Hz to 200 Hz to enable the supporting surface to electrostatically adsorb the recording medium, a line head having a nozzle through which an ink is ejected onto the recording medium transported with being electrostatically adsorbed to the supporting surface, and a member disposed in a region opposing the supporting surface. While the ink is ejected onto the recording medium, the distance between the member and the supporting surface is larger than the distance between the nozzle of the line head and the supporting surface.

The outer layer mentioned herein refers to the layer that defines the outermost circumference of the transport belt and will come into contact with the recording medium to support the recording medium thereon. The inner layer mentioned herein refers to a layer that does not come in contact with the recording medium, but may come into contact with, for example, a roller to drive the transport belt. The components of the transport belt are not limited to these layers, and an intermediate layer may be disposed between the outer layer and the inner layer. The term electrostatic adsorption refers to a phenomenon in which the recording medium adheres to the transport belt with an electrostatic force.

The “line head” mentioned herein is a type of recording head that is disposed in such a manner that the nozzle region thereof extends across the recording medium in a direction intersecting the direction in which the recording medium is transported, and that either the recording head or the recording medium moves to form images while the other is fixed. However, the nozzle region of the line head need not cover all the recording media that can be used in the recording apparatus in the direction intersecting the transport direction.

The “member disposed in a region opposing the supporting surface” refers to any member except the enclosure of the recoding apparatus, and may include the line head. Examples of such a member include, but are not limited to, a capping unit and a wiping unit.

The member disposed in the region opposing the supporting surface may be at least one of a capping unit and a wiping unit. This structure can minimize the increase in size of the recording apparatus.

However, this structure is likely to increase the coverage of the transport belt. The present inventors have found through their study that the phenomenon in which the recording medium cannot be easily adsorbed to the supporting surface of the transport belt can be minimized (decrease in electrostatic adsorption can be minimized) by increasing the distance between the member such as the capping unit or the wiping unit and the supporting surface so that moisture or the like derived from the ink ejected from the nozzle is not easily accumulated, and by charging the outer layer with an AC current with a frequency in the range of 10 Hz to 200 Hz. Thus, transport failure in transporting the recording medium caused by moisture can be minimized.

The transport belt may be capable of transporting the recording medium electrostatically adsorbed thereto at a relative humidity of 70% or more.

Recording apparatuses using a transport belt electrically charged with an AC current to support recording media are liable to be affected by moisture, and the moisture may make it difficult for the supporting surface to adsorb recording media. According to a study of the present inventors, the supporting surface cannot easily adsorb the recording medium particularly when transporting the recording medium at a relative humidity of 70% or more.

The recording apparatus of an embodiment of the invention is effective in minimizing the effect of moisture during the transport of the recording medium that may be performed at a relative humidity of 70% or more. Whether or not the transport belt of a recording apparatus is capable of transporting the recording medium at a relative humidity of 70% or more can be determined according to whether the recording apparatus has been designed so as to transport recording media under the condition of 70% or more in relative humidity.

The outer layer may have a surface resistivity of 10¹⁰ Ω/sq. or more, and the inner layer may have a volume resistivity in the range of 10⁵ Ω·cm to less than 10¹⁰ Ω·cm.

In this instance, the surface resistivity of the outer layer is larger than that of the inner layer, and accordingly, the charges at the outer layer migrate less easily than the charges at the inner layer. In addition, by controlling the volume resistivity of the inner layer in the above range, the phenomenon can be minimized in which the recording medium cannot be easily adsorbed to the transport belt.

The distance between the nozzle and the supporting surface of the transport belt may be 5 mm or less.

If the distance between the nozzle and the recording medium on the transport belt is increased, the droplets ejected from the nozzle are likely to land on positions deviating from intended positions and cause color unevenness in the recorded image. Accordingly, the distance between the nozzle and the supporting surface of the transport belt is desirably small and preferably 5 mm or less. However, if the distance between the nozzle and the supporting surface is small, moisture or the like derived from the ink ejected from the nozzle is likely to be accumulated around the transport belt.

In the above embodiment, even if the distance between the nozzle and the supporting surface of the transport belt is 5 mm or less, failure in transporting the recording medium caused by moisture can be minimized. The term “distance” mentioned herein refers to the distance of closest approach.

The ink may contain 20% to 75% by mass of water.

A high water content in the ink is more likely to cause the accumulation of moisture or the like derived from the ink ejected from the nozzle. The recording apparatus can minimize failure in transporting the recording medium caused by moisture even if the ink contains 20% to 75% by mass of water.

The member may cover 60% or more of the supporting surface of the transport belt when viewed from above in a path through which the recording medium is transported by the transport belt.

This percentage refers to the coverage of the transport belt and represents the ratio of the area of the member when viewed in a direction perpendicular to the supporting surface to the area of the supporting surface in the transport path. If the coverage during recording (while the ink is ejected onto the recording medium) is different from the coverage when the ink is not ejected, the coverage mentioned herein refers to the coverage during recording.

Since the coverage is 60% or more, the space in the recording apparatus can be efficiently used, and the increase in size of the recording apparatus can be minimized. The present inventors have found through their studies that even though the coverage is 60% or more, the phenomenon in which the recording medium cannot be easily adsorbed to the transport belt can be minimized by electrically charging the outer layer with an AC current with a frequency in the range of 10 Hz to 200 Hz. Thus, transport failure in transporting the recording medium caused by moisture can be minimized.

The member may be at least either a capping unit that comes in contact with the line head so as to cover the nozzle and to define a closed space with the line head or a wiping unit that wipes the surface of the line head in which the nozzle is formed.

Since the member disposed in the region opposing the supporting surface is at least either the capping unit or the wiping unit, the increase in size of the recording apparatus can be minimized.

When the member includes at least either the capping unit or the wiping unit, the recording apparatus may further include a transfer mechanism that transfers the line head in reciprocal directions in which the head comes close to and separates from the supporting surface of the transport belt, and the member includes the capping unit that can cap the line head. When the line head is capped with the capping unit, the distance between the capping unit and the supporting surface is larger than the distance between the nozzle and the supporting surface while the ink is ejected onto the recording medium.

When the line head is capped, recording is not performed, that is, the recording operation is stopped for a period of time. In an embodiment, when the line head is capped, a large distance may be given between the transport belt and the members disposed in the region opposing the supporting surface including the line head. This structure allows the moisture accumulated around the transport belt to be easily released. Thus, transport failure in transporting the recording medium caused by moisture can be minimized.

The recording apparatus may further include a tension adjusting mechanism capable of adjusting the tension on the transport belt. While recording operation is suspended, the tension adjusting mechanism reduces the tension on the transport belt relative to the tension during recording operation.

By reducing the tension on the transport belt during suspension, the degree of the bend in the transport belt formed by a tension roller can be reduced. Thus, the variation in the distance between the transport belt and the member such as the line head and the capping unit, caused by a bend in the transport belt can be minimized.

The transport belt may transport the recording medium at a speed of 8 inches per second or more.

By transporting the recording medium at such a speed on the transport belt, a positive charge and a negative charge can be alternately applied to the outer layer of the transport belt at appropriate intervals.

According to another aspect of the invention, a recording apparatus is provided which includes an endless transport belt including an inner layer and an outer layer containing a hydrophobic material and having a supporting surface on which a recording medium is supported, an AC charging device that electrically charges the supporting surface of the transport belt to enable the supporting surface to electrostatically adsorb the recording medium, a line head having a nozzle through which an ink is ejected onto the recording medium transported on the supporting surface with being electrostatically adsorbed to the supporting surface, and a member disposed in a region opposing the supporting surface. While the ink is being ejected onto the recording medium, the distance between the member and the supporting surface is larger than the distance between the nozzle of the line head and the supporting surface, and the AC charging device alternately applies a positive charge and a negative charge to the outer layer at intervals in the range of 3 mm to 20 mm in a direction parallel to the direction in which the recording medium is transported.

In this embodiment, positive and negative charges are alternately applied to the outer layer of the transport belt at appropriate intervals.

### BRIEF DESCRIPTION OF THE DRAWINGS

The invention will be described with reference to the accompanying drawings, wherein like numbers reference like elements.

FIG. 1 is a schematic side view of a recording apparatus according to an embodiment of the invention.

FIG. 2 is a schematic plan view a recording apparatus according to an embodiment of the invention.

### DESCRIPTION OF EXEMPLARY EMBODIMENTS

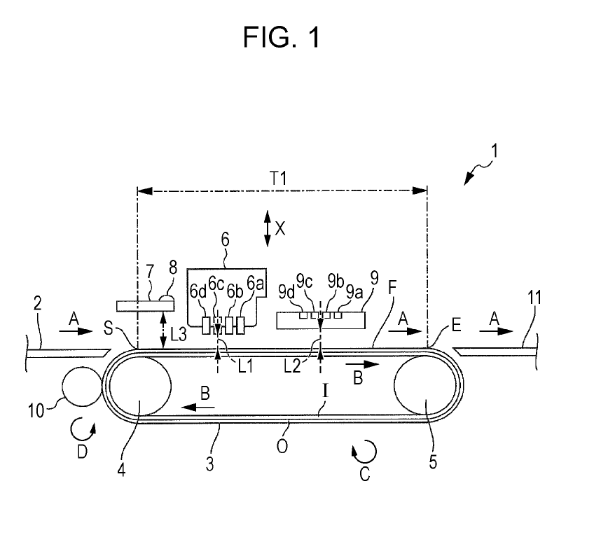

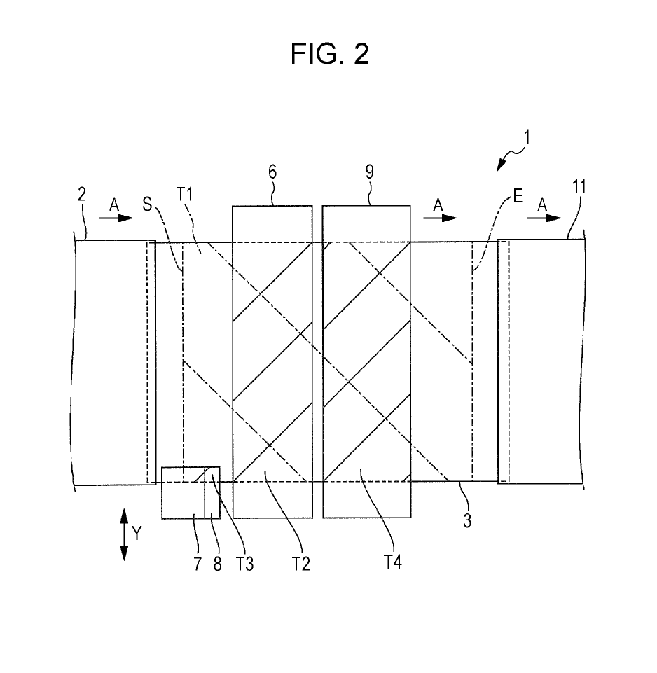

### Recording Apparatus (FIGS. 1 to 2)

A recording apparatus according to an embodiment of the invention will now be described with reference to the drawings. First, a recording apparatus 1 of an embodiment will be roughly described. FIG. 1 is a schematic side view of the recording apparatus 1, and FIG. 2 is a schematic plan view of the recording apparatus 1.

In the recording apparatus 1, a recording medium on which information will be recorded is transported from an entry 2 to a transport belt 3 in transport direction A in which the recording medium is transported. The recording medium is then supported on the transport belt 3, and transported in transport direction A by rotating a roller 4 in rotation direction C to move the transport belt 3 in direction B. Upon the rotation of the transport belt 3, a roller 5 is rotated while tensioning the transport belt 3. In the present embodiment, roller 4 drives the transport belt to rotate. However, roller 4 may be driven to rotate by rotating roller 5.

The path through which the transport belt 3 transports the recording medium (hereinafter referred to as transport path) starts at start point S and ends at end point E. In other words, the portion of the upper surface of the transport belt 3 from the start point S to the end point E (the portion opposing the line head 6 and other members) is the supporting surface F. The transport belt 3 includes an outer layer O that defines the outermost circumference of the transport belt 3 and will come into contact with the recording medium to support the recording medium, and an inner layer I in contact with the rollers 4 and 5 without coming into contact with the recording medium.

The transport path through which the transport belt transports the recording medium is provided with a line head 6 from which ink is ejected onto the recording medium transported with being electrostatically adsorbed to the supporting surface F. The recording apparatus 1 having such a structure can eject a black ink, a cyan ink, a magenta ink and a yellow ink. In the present embodiment, a plurality of line heads 6 are provided including a black ink line head 6a for the black ink, a cyan ink line head 6b for the cyan ink, a magenta ink line head 6c for the magenta ink, and a yellow ink line head 6d for the yellow ink. The surfaces of the line heads 6a to 6d opposing the transport belt 3 are provided with nozzles through which inks are ejected, thus acting as ink ejection surfaces.

The “line head” mentioned herein is a type of recording head that is disposed in such a manner that the nozzle region extends across the recording medium in a direction intersecting the transport direction in which the recording medium is transported, and that either the recording head or the recording medium moves to form images while the other is fixed. However, the nozzle region of the line head need not cover all the recording media that can be used in the recording apparatus in the direction intersecting the transport direction. The term electrostatic adsorption refers to a phenomenon in which the recording medium adheres to the transport belt 3 with an electrostatic force.

The recording apparatus 1 of the present embodiment further includes a wiping unit 7 having a wiping member 8 upstream from the line heads 6 in transport direction A for wiping the ink ejection surfaces provided with the nozzles. Furthermore, the recording apparatus 1 includes a capping unit 9 downstream from the line heads 6 in transport direction A. The capping unit 9 will come in contact with the line heads 6 so as to cover the nozzles and defines a closed space with the line heads 6. Thus, the recording apparatus 1 of the present embodiment has the capping unit 9 and the wiping unit 7 as the member disposed in the region opposing the supporting surface F of the transport belt 3, thus minimizing the increase in size thereof. The recording apparatus 1 is however not limited to this structure as long as it includes at least one member, such as the capping unit or the wiping unit 7, in the region opposing the supporting surface F of the transport belt 3.

The wiping member 8 is made of absorbent cloth and is independently replaceable. The absorbent wiping member 8 can prevent ink from dripping from the line head during wiping. Also, the wiping member 8 can be independently replaced separate from the other members of the wiping unit 7, the running cost of the recording apparatus can be reduced. The wiping member 8 is however not limited to this, and may be, for example, a wiper blade made of an elastic member. The wiping unit 7 is configured to wipe the ink ejection surfaces for each ink color. This allows the wiping unit 7 to be downsized. Thus, the increase in size of the recording apparatus 1 is minimized.

The capping unit 9 includes caps 9a to 9d corresponding to the line heads 6a to 6d. The capping unit also doubles as a suction unit to suck the ink in the nozzles of the line heads 6a to 6d together using a pump (not shown).

The positional relationship among the line heads 6, the wiping unit 7 and the capping unit 7 shown in FIGS. 1 and 2 is that during recording (when the ink is ejected onto the recording medium). The line heads 6 can be reciprocally moved in directions X in which they come close to and separate from the transport belt 3 by a transfer mechanism (not shown). The wiping unit 7 and the capping unit 9 can be transferred in the direction parallel to transport direction A by a transfer mechanism (not shown).

For wiping, the wiping unit 7 is thus transferred to a position between the line heads 6 and the transport belt 3 while the line heads 6 are transferred in a direction in which they separate from the transport belt 3 away from the position during recording. Then, the wiping unit 7 is moved in directions Y to wipe the line heads 6.

For capping, the capping unit 9 is also transferred to a position between the line heads 6 and the transport belt 3 while the line heads 6 are moved in a direction in which they separate from the transport belt 3 away from the position during recording. The line heads 6 are then transferred to come close to the transport belt 3 so that the line heads 6a to 6d can align with the caps 9a to 9d respectively. The line heads 6a to 6d are thus capped with the caps of the capping unit 9.

In the recording apparatus 1 of the present embodiment, the line heads 6, the wiping unit 7 and the capping unit 9 are each the member disposed in the region opposing the supporting surface F of the transport belt 3 in the transport path through which the recording medium is transported by the transport belt 3. In the recording apparatus 1 of the present embodiment, the transport path is from the start point S to the end point E. The portion of the supporting surface F of the transport belt 3 in the transport path has an area T1. The portion of the line heads 6 over the transport path has an area T2 when viewed in the direction perpendicular to the supporting surface F. The portion of the wiping unit 7 over the transport path has an area T3 when viewed in the direction perpendicular to the supporting surface F. Also, the portion of the capping unit 9 over the transport path has an area T4 when viewed in the direction perpendicular to the supporting surface F. Hence, the coverage (%) of the supporting surface F of the transport belt 3 with the members disposed in the region opposing the supporting surface F is expressed by ((T2+T3+T4)/T1)×100, and the coverage in the recording apparatus 1 is 60% or more in plan view. The distances from the portion of the supporting surface F in the transport path to the members disposed in the region opposing the supporting surface F of the transport belt 3 in the transport path are preferably each 40 cm or less. For further downsizing the recording apparatus 1, the distances are each 30 cm or less, preferably 20 cm or less.

In the present embodiment, the members disposed in the region opposing the supporting surface F of the transport belt 3 in the transport path includes the line heads 6, the wiping unit 7 and the capping unit 9. However, the members are not limited to these units or devices, and may include any of the components of the recording apparatus except the enclosure. The term “coverage” mentioned herein refers to the ratio of the area in the transport path of the members covering the supporting surface F when viewed downward in a direction perpendicular to the supporting surface F (in plan view) to the area in the transport path of the supporting surface F, as described above. If the coverage during recording (while the ink is ejected onto the recording medium) is different from the coverage when the ink is not ejected, the coverage mentioned herein refers to the coverage during recording.

By arranging the members with a coverage of 60% or more, the space in the recording apparatus can be efficiently used, and the increase in size of the recording apparatus can be minimized. The present inventors have found through their studies that even though the coverage is 60% or more, the phenomenon in which the recording medium cannot be easily adsorbed to the transport belt 3 can be minimized by electrically charging the outer layer O of the transport belt 3 with an AC current with a frequency in the range of 10 Hz to 200 Hz. As will be described later, in the present embodiment, the outer layer O of the transport belt 3 is electrically charged with an AC current with a frequency in the range of 10 Hz to 200 Hz. Consequently, failure in transporting the recording medium caused by moisture can be minimized.

In the recording apparatus 1 of the present embodiment, distance L1 (platen gap PG) between the nozzles of the line heads 6 and the transport belt 3 during recording (while ink is ejected onto the recording medium) is 5 mm or less. When at least either distance L2 between the capping unit 9 and the transport belt 3 during recording or distance L3 between the wiping unit 7 and the transport belt 3 during recording is larger than distance L1, moisture or the like derived from the ink ejected through the nozzles can be easily released without being accumulated. In the present embodiment, both distances L2 and L3 are larger than distance L1 as shown in FIG. 1, and accordingly moisture is more easily released advantageously. In another embodiment, however, at least either distance L2 or distance L3 may be larger than distance L1.

If the distance between the nozzles and the recording medium on the transport belt 3 is long, the droplets ejected from the nozzles are likely to land on positions deviating from intended positions and cause color unevenness in the recorded image. Accordingly, the distance between the nozzles and the supporting surface F of the transport belt 3 is desirably small and preferably 5 mm or less. However, if the distance between the nozzles and the supporting surface F of the transport belt 3 is small, moisture or the like derived from the ink ejected from the nozzles is likely to be accumulated to fill the space around the transport belt. In the recording apparatus 1 of the present embodiment, even if the distance between the nozzles and the supporting surface F of the transport belt 3 is 5 mm or less, failure in transporting the recording medium caused by moisture can be minimized. The term “distance” mentioned herein refers to the distance of closest approach.

In the present embodiment, distance L3 between the wiping unit 7 (member disposed upstream from the line head 6 in transport direction A) and the supporting surface F is larger than distance L2 between the capping unit 9 (member disposed downstream from the line head 6 in transport direction A) and the supporting surface F. However, in another embodiment, distance L2 between a member disposed downstream from the line head 6 in transport direction A and the supporting surface F may be larger than distance L3 between a member disposed upstream from the line head 6 in transport direction A and the supporting surface F. These structures help minimize the interference between the curled recording medium immediately after recording and the downstream member. Distance L2 is preferably in the range of 2.0 mm to 10.0 mm. Distance L3 is preferably larger than L2, more preferably twice or more as large as distance L2, and still more preferably three times or more as large as distance L2.

In the recording apparatus 1 of the present embodiment, the distance between the capping unit 9 and the transport belt 3 maintains distance L2 at both times when recording is performed and when nozzles are capped. In other words, the distance between the capping unit 9 and the transport belt 3 when the line heads 6 are capped with the caps of the capping unit 9 is larger than distance L1 between the nozzles of the line heads 6 and the transport belt 3 during recording. When the line heads 6 are capped, recording is not performed, that is, the recording operation is suspended for a period of time.

As described above, in the recording apparatus 1 of the present embodiment, large distances are given between the transport belt 3 and each of the members disposed in the region opposing the supporting surface F, such as the capping unit 9 and the line heads 6, when the line heads 6 are capped. This structure allows the moisture accumulated around the transport belt to be easily released. Thus, transport failure in transporting the recording medium caused by moisture can be minimized.

The recording apparatus 1 is configured to minimize the dripping of ink droplets onto the supporting surface F of the transport belt 3 when the ink ejection surfaces are wiped, by locating the capping unit 9 under the line heads 6. In the recording apparatus 1 having such a structure, the wiping unit 7 is more distant from the supporting surface F than the capping unit 9, in direction X in which the line heads 6 are moved. Hence, the wiping unit 7 is disposed at a higher position in the vertical direction than the capping unit 9. If this positional relationship is taken at least when wiping is not performed, the capping unit 9 and the wiping unit 7 can be transferred separately in the horizontal direction for wiping operation. Accordingly, the mechanism for transferring these members can be simplified.

In addition, since the wiping unit 7 is disposed above the capping unit 9, the wiping unit 7 can be located at a position as high as possible, thereby preventing the accumulation of mist. Also, for example, when the capping unit 9 is flushed, the operations of the line heads 6 and the capping unit 9 can be simple.

In the recording apparatus 1 of the present embodiment, the line heads 6, the wiping unit 7 and the capping unit 9 are arranged in a line in transport direction A. However, the arrangement of these members is not limited to this, and they may be arranged in a direction intersecting transport direction A.

In the recording apparatus 1 of the present embodiment, when recording is not performed, for example, when the line heads are capped, the members disposed in the region opposing the supporting surface F of the transport belt 3 are displaced, and thus the coverage of the transport belt 3 with the members is reduced relative to that during recording. The recording apparatus having such a structure easily releases moisture accumulated around the transport belt 3 when recording is not performed. However, the invention is not limited to such a structure.

Since the transport belt 3 is of electrostatic adsorption type, the recording apparatus 1 further includes a charging roller 10 as an AC charging device that electrically charges the supporting surface F of the transport belt 3 with an AC current (alternating current) by alternately applying a positive charge and a negative charge to the transport belt 3 so that the recording medium can be electrostatically adsorbed to the supporting surface F. The charging roller 10 is rotated in direction D by the movement of the transport belt 3.

In the present embodiment, the charging roller 10 is configured to electrically charge the outer layer O (supporting surface F) of the transport belt 3 with an AC current with a frequency in the range of 10 Hz to 200 Hz. The frequency of the AC current is preferably in the range of 20 Hz to 100 Hz, more preferably 30 Hz to 60 Hz.

As described above, the structure like that of the recording apparatus 1 of the present embodiment, in which at least one of members such as capping unit 9 and wiping unit 7 is disposed in the region opposing the supporting surface F, can minimize the increase in size of the recording apparatus. However, this structure allows the members disposed in the region opposing the transport belt 3 to cover a larger part of the supporting surface F in the transport path. The present inventors have found through their studies that the phenomenon in which the recording medium cannot be easily adsorbed to the supporting surface F of the transport belt 3 can be minimized (decrease in electrostatic adsorption can be minimized) by increasing the distance between at least either the capping unit 9 or the wiping unit 7 and the supporting surface F so that moisture or the like derived from the ink ejected from the nozzles is not easily accumulated, and by charging the outer layer O with an AC current with a frequency in the range of 10 Hz to 200 Hz. Thus, the recording apparatus 1 of the present embodiment can minimize failure in transporting the recording medium caused by moisture.

Preferably, the transport belt 3 moves at a speed of 8 inches per second for transporting the recording medium. More preferably, it is in the range of 8 to 80 inches per second. By electrically charging the outer layer O of the transport belt 3 with an AC current with a frequency in the above range and moving the transport belt 3 at the above speed, a positive charge and a negative charge are alternately applied to the outer layer O of the transport belt 3 at appropriate intervals. More specifically, the charging roller 10 can alternately apply a positive charge and a negative charge to the outer layer O at intervals of, for example, 3 mm to 20 mm in transport direction A. If the moving speed of the transport belt exceeds 80 inches per second, the charging interval is reduced so much that the transport of the recording medium is seriously affected by moisture or the like.

In the present embodiment, the tension on the transport belt 3 can be adjusted by a tension adjusting mechanism (not shown) capable of adjusting the tension on the transport belt 3 so that the tension under the suspension of recording operation can be lower than that during recording. By reducing the tension of the transport belt 3 under the suspension, the degree of the bend in the transport belt 3 formed by the tension roller can be reduced. Thus, the variation in the distance between the transport belt 3 and the members such as the line heads 6 and the capping unit 9, caused by a bend in the transport belt 3 can be minimized.

Finally, the recording medium on which information has been recorded is transported to an ejection portion 11 from the transport belt 3. In the recording apparatus 1 of the present embodiment, a recording medium have a length in transport direction A of 30 cm or more (for example, A3 size sheet) can be transported. If a portion to which the recording medium cannot be easily adsorbed occurs in the transport belt 3 particularly when a recording medium long in the transport direction is transported, the recording medium is not adsorbed to that portion and is likely to separate from the transport belt 3 to bulge at that portion. Therefore, for a recording apparatus capable of transporting recording media long in the transport direction, it is desired to minimize effectively the occurrence of a portion of the transport belt 3 to which recording media cannot be easily adsorbed. In the recording apparatus 1 of the present embodiment, which can transport recording media having a length in the transport direction of 30 cm or more, the above-described structure minimizes transport failure in transporting the recording medium caused by moisture.

The recording apparatus 1 can perform recording even under the condition of 70% or more in relative humidity. Hence, the transport belt 3 can transport recording media under the condition of at least 70% in relative humidity. Recording apparatuses using a transport belt electrically charged with an AC current to support recording media are liable to be affected by moisture, and the moisture may make it difficult for the supporting surface to adsorb recording media. According to a study of the present inventors, the supporting surface cannot easily adsorb the recording medium particularly when transporting the recording medium at a relative humidity of 70% or more. The recording apparatus of an embodiment of the invention is effective in minimizing the effect of moisture during the transport of the recording medium that may be performed at a relative humidity of 70% or more. Whether or not the transport belt of a recording apparatus is capable of transporting the recording medium at a relative humidity of 70% or more can be determined according to whether the recording apparatus has been designed so as to transport recording media under the condition of 70% or more in relative humidity.

### Transport Belt

The transport belt 3 will now be described. The transport belt 3 is an endless belt including an inner layer I and an outer layer O containing a hydrophobic material, and transports a recording medium supported on the supporting surface F defined by the outer layer O. The transport belt 3 may further includes an intermediate layer between the inner layer I and the outer layer O, and thus may have a double-layer structure or a structure including three layers or more. Preferably, the transport belt 3 has a water absorption, specified in JIS K 7209, of 0.1% or less.

The inner layer I may be made of any material without particular limitation. For example, it may be made of an electroconductive polyimide resin from the viewpoint of ensuring the mechanical strength of the transport belt 3 and electrical continuity for electrostatic adsorption. Polyimide resin can form a film in which the dimensions are not varied much or bent or swollen much by environmental changes and accordingly the variation in circumference can be small, through process steps of removing the solvent and eliminating residual strain by crosslink formation for imidization. Preferably, the volume resistivity of the inner layer I is 10⁵ Ω·cm or more and less than 10¹⁰ Ω·cm. The inner layer I preferably has a thickness in the range of 50 μm to 150 μm from the viewpoint of the manufacture of the transport belt 3 and the hardness of the transport belt 3.

The electroconductive polyimide resin in the inner layer I contains a polyimide resin and a conductive material. Examples of the polyimide resin include thermoplastic polyimide, thermosetting polyimide, polyetherimide, and polyamidoimide. The use of such a polyimide resin can prevent the transport belt 3 from being deformed by tension produced by driving and driven rollers, and helps the transport belt adsorb the recording medium stably. Preferably, a thermosetting polyimide is used.

A favorable thermosetting polyimide resin may be produced by a reaction of an aromatic tetracarboxylic acid component and an aromatic diamine component in an organic solvent.

Examples of the aromatic tetracarboxylic acid component include pyromellitic acid, naphthalene-1,4,5,8-tetracarboxylic acid, 2,2′,3,3′-biphenyltetracarboxylic acid, naphthalene-2,3,6,7-tetracarboxylic acid, 2,3,5,6-biphenyltetracarboxylic acid, 3,3′,4,4′-diphenyl ether tetracarboxylic acid, 3,3′,4,4′-benzophenone tetracarboxylic acid, 3,3′,4,4′-diphenyltetracarboxylic acid, 3,3′,4,4′-diphenylsulfonetetracarboxylic acid, 3,3′,4,4′-azobenzenetetracarboxylic acid, bis(2,3-dicarboxyphenyl)methane, bis(3,4-dicarboxyphenylmethane), bis(3,4-dicarboxyphenylpropane), bis(3,4-dicarboxyphenyl)hexafluoropropane, and dianhydrides thereof. These may be used singly or in combination. Among these, 3,3′,4,4′-diphenyltetracarboxylic acid or dianhydride thereof and pyromellitic acid are preferred.

Examples of the aromatic diamine component include m-phenyldiamine, p-phenyldiamine, 2,4-aminotoluene, 2,6-aminotoluene, 2,4-diaminochlorobenzene, m-xylylenediamine, diaminonaphthalene, 2,6-diaminonaphthalene, 2,4′-diaminonaphthalenebiphenyl, benzidine, 3,3-dimethylbenzidine, 3,3′-dimethoxybenzidine, 3,4′-diaminodiphenyl ether, 4,4′-diaminodiphenyl ether (ODA), 4,4′-diaminodiphenyl sulfide, 3,3′-diaminobenzophenone, 4,4′-diaminophenyl sulfone, 4,4′-diaminoazobenzene, 4,4′-diaminodiphenylmethane, and bis(aminophenyl) propane. p-Phenyldiamine or 4,4′-diaminodiphenyl ether (ODA) is preferred.

Examples of the organic solvent include N-methyl-2-pyrrolidone, N,N-dimethylacetamide, dimethyl sulfoxide, and hexamethylphosphoramide. The organic solvent may contain a phenol, such as cresol, phenol, or xylenol, or a hydrocarbon, such as hexanebenzene or toluene, if necessary. These compounds may be used singly or in combination.

If a thermoplastic polyimide is used, it can be prepared from a combination of an aromatic tetracarboxylic acid component and an aromatic diamine component. The aromatic tetracarboxylic acid component can be selected from those cited for the above-described thermosetting polyimide, and the aromatic diamine component may be, for example, bis[4-{3-(4-aminophenoxy)benzoyl}phenyl]ether, 4,4′-bis(3-aminophenoxy)biphenyl, bis[4-(3-aminophenoxy)phenyl]sulfide, or 2,2′-bis[4-(3-aminophenoxy)phenyl]propane.

If a polyetherimide is used, it can also be prepared from an appropriate combination of an aromatic diamine component and an aromatic tetracarboxylic acid component. The aromatic diamine component can be selected from those cited for the above-described thermosetting polyimide, and the aromatic tetracarboxylic acid component may be bisphenol-A tetracarboxylic dianhydride.

If a polyamidoimide is used as the polyimide resin, it can be produced from trimellitic anhydride and an aromatic diamine component selected from those cited for the thermosetting polyimide.

The electroconductive material may be an electron conductive material or an ion conductive material. Examples of the electron conductive material include fillers of carbon black, graphite, aluminum, nickel or copper, and oxides or complex oxides, such as tin oxide, zinc oxide, potassium titanate, indium oxide, tin oxide-indium oxide, and antimony oxide. Examples of the ion conductive material include ammonium salts, sulfonates, cationic surfactants, nonionic surfactants, and anionic surfactants.

Carbon black can be preferably used as the electroconductive material. Exemplary carbon black include gas black, acetylene black, oil furnace black, thermal black, channel black, and Ketjen black. Ketjen black, acetylene black and oil furnace black can impart a desired electric conductivity even in a small amount. Ketjen black is a type of conductive furnace black.

The outer layer O can be made of any material as long as containing a hydrophobic material, and may contain an ethylene-tetrafluoroethylene copolymer (ETFE) as the hydrophobic material from the viewpoint of enhancing the electrostatic adsorptivity of the transport belt 3. The ethylene-tetrafluoroethylene copolymer helps the outer layer O maintain high electrostatic adsorptivity to the recording medium and allows the recording medium to separate from the outer layer O after neutralization. In addition, ethylene-tetrafluoroethylene copolymer exhibits high cleaning power.

Preferably, the outer layer O has a surface resistivity of 10¹⁰ Ω/sq. or more. More preferably, the surface resistivity is 10¹² Ω/sq. or more. Preferably, the outer layer O has a water absorption, specified in JIS K 7209, of 0.1% or less. In addition, the thickness of the outer layer O is preferably in the range of 10 μm to 80 μm. The surface resistivity and volume resistivity can be measured with a resistivity meter such as MCP-T610, MCP-T360, MCP-HT450, MCP-S620 or MCP-521, each manufactured by Mitsubishi Chemical Analytech.

The ethylene-tetrafluoroethylene copolymer in the outer layer O contains ethylene and tetrafluoroethylene, and the mole ratio of the ethylene to the tetrafluoroethylene is in the range of 60/40 to 40/60, preferably 45/55 to 55/45. Also, the melt flow rate (MFR) at 5.0 kg and 297° C. of the ethylene-tetrafluoroethylene copolymer is not particularly limited as long as the copolymer can form a tubular film, and is normally 4 to 9, preferably 4 to 7.2, and more preferably 5 to 7.2. From the viewpoint of improving the crystallinity, the copolymer may contain a small amount of another constituent. Examples of the ethylene-tetrafluoroethylene copolymer include Tefzel 290 produced by Du Pont Mitsui Fluorochemical and Fluon ETFE C-55AXB produced by Asahi Glass. The ethylene-tetrafluoroethylene copolymer may contain a material that can have adhesiveness and can adhere to other materials. The ethylene-tetrafluoroethylene copolymer exhibits characteristic infrared absorption spectrum in the region of 1720 cm⁻¹ to 1800 cm⁻¹. Such an ethylene-tetrafluoroethylene copolymer may be that disclosed in JP-A-11-320770. Fluon LM-ETFE AH2000 produced by Asahi Glass is a commercially available example of such an ethylene-tetrafluoroethylene copolymer.

The inner surface of the outer layer O containing the ethylene-tetrafluoroethylene copolymer may be chemically treated by, for example, chemical etching to enhance the adhesion with the inner layer I containing an electroconductive polyimide resin. The inner layer I and the outer layer O are thus prevented from separating from each other through long-time use, and thus a long-life transport belt 3 can be achieved.

As described above, the transport belt 3 of the present embodiment includes the outer layer O having a surface resistivity of 10¹⁰ Ω/sq. or more, and the inner layer I having a volume resistivity in the range of 10⁵ Ω·cm to less than 10¹⁰ Ω·cm. Hence, the volume resistivity of the outer layer O is higher than that of the inner layer I, and accordingly the charges at the outer layer migrate less easily than the charges at the inner layer I. By controlling the surface resistivity of the outer layer O and the volume resistivity of the inner layer in the above ranges, the phenomenon can be minimized in which the recording medium cannot be easily adsorbed to the transport belt.

### Ink

The ink that can be used in the recording apparatus of the present embodiment will now be described. Although any ink can be used without particular limitation, the ink is preferably an aqueous ink containing 20% to 75% by mass of water. Since water is odorless and does not cause environmental deterioration, the ink preferably contains 20% by mass or more of water. On the other hand, from the viewpoint of minimizing the occurrence of a curl in the recorded recording medium and the phenomenon in which moisture derived from the ink ejected through the nozzles causes adjacent opposite charges at the AC charged supporting surface to cancel each other out, the water content of the ink is preferably 75% by mass or less. The water content is preferably in the range of 30% to 70% by mass.

The charged condition of the recorded recording medium on the transport belt 3 depends on the ink used for recording. More specifically, when different inks are used in the recording apparatus, the suitable range of frequency of the AC current for electrically charging the outer layer (supporting surface F) of the transport belt 3 depends on the ink to be used. It is therefore desirable that the composition of the ink and the frequency of the AC current for electrically charging the outer layer O be associated with each other.

The ink may contain a coloring material, water, a water-soluble organic solvent, a resin, and a surfactant. An arbitrary amount of a dye or a pigment can be used as the coloring material. If a dye is used, it may be selected from various types of dye used for ink jet recording, such as direct dyes, acid dyes, food dyes, basic dyes, reactive dyes, disperse dyes, vat dyes, soluble vat dyes, and reactive disperse dyes.

If a pigment is used, it may be an inorganic pigment or an organic pigment without particular limitation. Exemplary inorganic pigments that can be used for black inks include carbon blacks (C. I. Pigment Black 7), such as furnace black, lampblack, acetylene black, and channel black, in addition to titanium oxide and iron oxide. Organic pigments for black inks include black organic pigments, such as aniline black (C. I. Pigment Black 1). Exemplary cyan pigments include phthalocyanine pigments, such as C. I. Pigment Blues 15:3 and 15:4.

Exemplary pigments for yellow inks include C. I. Pigment Yellows 1 (Hansa Yellow), 3 (Hansa Yellow 10G), 12, 13, 14, 17, 24 (flavanthrone yellow), 34, 35, 37, 53, 55, 65, 73, 74, 81, 83, 93, 94, 95, 97, 98, 99, 108 (anthrapyrimidine yellow), 109, 110, 113, 117 (copper complex salt pigment), 120, 128, 133 (quinophthalone), 138, 139 (isoindolinone), 147, 151, 153 (nickel complex salt pigment), 154, 155, 167, 172, 180, 185 and 213, and pigments expressed by chemical formula I disclosed in International Publication No. WO 2011/027842.

Exemplary pigments for magenta inks include C. I. Pigment Reds 1 (Para Red), 2, 3 (toluidine red), 5 (ITR Red), 7, 9, 10, 11, 12, 17, 30, 31, 38 (pyrazolone red), 42, 88 (thioindigo), 112 (Naphthol AS-based pigment), 114 (Naphthol AS-based pigment), 122 (dimethylquinacridone), 123, 144, 149, 150, 166, 168 (anthrone orange), 170 (Naphthol AS-based pigment), 171, 175, 176, 177, 178, 179 (perylene maroon), 185, 187, 209 (dichloroquinacridone), 219, 224 (perylene-based pigment) and 245 (Naphthol AS-based pigment), and C. I. Pigment Violets 19 (quinacridone), 23 (dioxazine violet), 32, 33, 36, 38, 43 and 50.

Water used in the ink is preferably pure water or ultrapure water, such as ion exchanged water, ultrafiltered water, reverse osmotic water, or distilled water, but is not particularly limited. The water content of the ink is preferably in the range of 20% to 75% by mass.

The water-soluble organic solvent may be a polyhydric alcohol, a pyrrolidone derivative or a glycol ether. These solvents can be used in an arbitrary content. The water-soluble organic solvent may be constituted of a single compound or may contain two or more compounds.

Examples of the polyhydric alcohol include ethylene glycol, diethylene glycol, triethylene glycol, polyethylene glycol, polypropylene glycol, dipropylene glycol, propylene glycol, butylene glycol, 1,2-butanediol, 1,2-pentanediol, 1,5-pentanediol, 1,2-hexanediol, 2-ethyl-1,3-hexanediol, 1,6-hexanediol, 1,2-heptanediol, 1,2-octanediol, 1,2,6-hexanetriol, thioglycol, hexylene glycol, glycerin, trimethylolethane, and trimethylolpropane. Polyhydric alcohol can minimize the clogging of nozzle apertures with the ink composition ejected through the nozzle apertures of the recording apparatus.

Examples of the pyrrolidone derivative include N-methyl-2-pyrrolidone, N-ethyl-2-pyrrolidone, N-vinyl-2-pyrrolidone, 2-pyrrolidone, and 5-methyl-2-pyrrolidone.

Examples of the glycol ether include triethylene glycol monobutyl ether, diethylene glycol monobutyl ether, dipropylene glycol propyl ether, and diethylene glycol diethyl ether.

The resin may be soluble in a solvent or may be particles in a state of emulsion or suspension. By adding resin particles to the ink, images having superior rub fastness can be formed on the recording medium. In the present embodiment, the resin particles in the ink are preferably in the state of an emulsion or a suspension. The viscosity of an ink containing resin particles in such a state is easy to adjust in a range suitable for ink jet recording, and the ink can be stably stored and stably ejected.

The resin particles may be polymer particles that can form a resin coating and be fixed to the recording medium. Examples of the material of such polymer particles include polyacrylic esters and their copolymers; polymethacrylic esters and their copolymers; polyacrylonitriles and their copolymers; polycyanoacrylate, polyacrylamide, polyacrylic acid, polymethacrylic acid, polyethylene, polypropylene, polybutene, polyisobutylene, polystyrene and their copolymers; petroleum resin; chromane-indene resin; terpene resin; polyvinyl acetates and their copolymers; polyvinyl alcohols; polyvinyl acetals; polyvinyl ethers; polyvinyl chlorides and their copolymers; polyvinylidene chloride; fluorocarbon polymers; fluorine rubbers; polyvinyl carbazole; polyvinyl pyridine; polyvinyl imidazole; polybutadienes and their copolymers; polychloroprene; polyisoprene; and natural resins. Preferably, the molecule of the resin particles has a structure having both a hydrophobic portion and a hydrophilic portion.

Preferably, the resin particles have an average particle size of 5 nm to 400 nm, more preferably 50 nm to 200 nm, from the view point of ensuring stable storage and stable ejection of the ink composition. For measuring the particle size, a particle size distribution meter Microtrac UPA manufactured by Nikkiso Co., Ltd., which uses a dynamic light scattering method, may be used.

If the ink contains resin particles, the resin particle content of the ink is preferably in the range of 0.5% to 10% by mass relative to the total mass of the ink. The resin particles with such a content can help the solidification and fixing of the ink on or to the recording medium.

The surfactant may be an anionic surfactant, a cationic surfactant, an amphoteric surfactant or a nonionic surfactant, and these surfactants may be used in an arbitrary content. Nonionic surfactants are preferred, and at least either a silicone surfactant or an acetylene glycol-based surfactant is particularly preferably used.

Surfactants allow the ink to maintain an appropriate surface tension and an appropriate interfacial tension with the printer components, such as nozzles, that will come into contact with the ink. Accordingly, an ink containing a surfactant can be stably ejected from the recording apparatus. In addition, surfactants enable the ink to spread evenly on the recording medium.

For example, polysiloxane compounds such as polyether-modified organosiloxane are preferred silicone surfactants. More specifically, silicone surfactants include BYK-306, BYK-307, BYK-333, BYK-341, BYK-345, BYK-346, and BYK-348 (each, product of BYK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (each, product of Shin-Etsu Chemical Co., Ltd.).

Preferably, the ink does not substantially contain 1,2-alkanediol having a carbon number of 5 or 6. These organic solvents are likely to break ejected ink droplets and thus cause a large amount of mist to be produced. Therefore, it is desirable that the ink do not substantially contain 1,2-alkanediol having a carbon number of 5 or 6 so as to reduce water vapor as much as possible.

The phrase “not substantially contain” mentioned herein means that the substance is not added on purpose or is added in such a small amount that it is ineffective. In other words, the ink may contain a trace amount of the substance inevitably added during preparation or storage. For example, the ink does not contain 1,2-alkanediol having a carbon number of 5 or 6 in an amount of 1.0% by mass or more, preferably 0.5% by mass or more, more preferably 0.1% by mass or more, still more preferably 0.05% by mass or more, and particularly preferably 0.01% by mass or more.

In the present embodiment, the water content of the ink used in the recording apparatus 1 is in the range of 20% to 75% by mass. A high water content in the ink is more likely to cause the accumulation of moisture or the like derived from the ink ejected from the nozzles. However, the recording apparatus 1 of the present embodiment can minimize failure in transporting the recording medium caused by moisture even if the ink contains 20% to 75% by mass of water.

### EXAMPLES

The invention will be further described in detail with reference to Examples, Reference Examples and Comparative Examples. A black ink, a cyan ink, a magenta ink and a yellow ink each having the composition shown in Table 1 were prepared in a known process. The pigments were carbon black for the black ink, Pigment Blue 15:3 for the cyan ink, Pigment Violet 19 for the magenta ink, and Pigment Yellow 74 for the yellow ink.

TABLE 1

| | Percent |
|---|---|
| | by |
| Composition | mass |
| Pigment | 8.0 |
| Styrene-acrylic resin 1 (Glass transition temperature Tg: | 1.0 |
| −60° C., water-soluble) | |
| Styrene-acrylic resin 2 (Glass transition temperature Tg: 75° C., | 2.0 |
| Particle size D50: 90 nm) | |
| Newcol 1004 (Polyoxyethylene alkyl ether, produced by Nippon | 1.0 |
| Nyukazai) | |
| Glycerol | 4.0 |
| Triethylene glycol | 2.0 |
| Trimethylolpropane | 6.0 |
| 2-Pyrrolidone | 4.0 |
| Triethylene glycol monobutyl ether | 2.0 |
| Surfynol 465 (produced by Air Products and Chemicals Inc.) | 0.5 |
| Olfine E1010 (produced by Nissin Chemical Industry) | 0.5 |
| Tripropanolamine | 0.5 |
| Disodium ethylenediaminetetraacetate | 0.01 |
| Ion exchanged water | 68.49 |

Recording apparatuses were produced for Examples 1 to 3, Reference Examples 1 to 3 and Comparative Examples 1 and 2. The recording apparatuses had a structure as shown in FIGS. 1 and 2 and properties shown in Table 2. Charged belts 1 to 3, corresponding to the transport belt, had properties shown in Table 3. The recording apparatuses were charged with the inks shown in Table 1 and were then allowed to stand under the conditions of the relative humidities shown in Table 2 and 40° C. for 12 hours. Then, recording was performed on 50 A3-size recording media having a length of cm in the transport direction, and it was evaluated according to the following criteria whether the recording media had been properly transported. The results were shown in Table 2 as transport adsorption. Capability for space saving was also evaluated.

Good: Normal transport was performed at a platen gap PG of 1.0 mm.

Fair: Normal transport was performed at a PG of 1.5 mm, but there was acceptable interference between the recording medium and a component member at a PG of 1.0 mm.

Bad: The recording medium was often jammed at a PG of 1.5 mm, and this is unacceptable.

TABLE 2

| | Example | Example | Example | Reference | Reference | Reference | Comparative | Comparative |
|---|---|---|---|---|---|---|---|---|
| | 1 | 2 | 3 | Example 1 | Example 2 | Example 3 | Example 1 | Example 2 |
| Charged belt | 1 | 1 | 3 | 1 | 1 | 2 | 2 | 2 |
| Coverage (%) | 80 | 80 | 80 | 80 | 80 | 80 | 40 | 40 |
| Surface | Had | Had | Had | Had | Had | None | Had | None |
| hydrophobicity | | | | | | | | |
| Frequency | 50 | 75 | 50 | 8 | 250 | 50 | 50 | 50 |
| (Hz) | | | | | | | | |
| Relative | 75 | 75 | 75 | 75 | 75 | 30 | 75 | 75 |
| humidity (%) | | | | | | | | |
| Transport | Good | Fair | Good | Bad | Bad | Good | Good | Bad |
| adsorption | | | | | | | | |
| Space saving | Good | Good | Good | Good | Good | Good | Bad | Bad |

TABLE 3

| | Charged belt 1 | Charged belt 2 | Charged belt 3 |
|---|---|---|---|
| Outer layer material | ETFE | Polyimide | Polyimide of the |
| Inner layer material | Polyimide | Polyimide | inner layer of |
| Outer layer surface | 1.2 × 10¹² | 1.2 × 10¹² | charged belt 1, |
| resistivity (Ω/sq.) | | | coated with |
| Inner layer volume | 7.5 × 10⁶ | 4.5 × 10⁶ | fluorocarbon |
| resistivity (Ω · cm) | | | |

The fluorocarbon coating of charged belt 3 was formed by solidifying polytetrafluoroethylene at 40° C. at a transport speed of 15 ips (inches per second). The surface resistivity of the outer layer was measured at a temperature of 23° C. and a relative humidity of 55% using a ring electrode “URS probe” of a resistivity meter Hiresta UP or a four-pin probe of Loresta, each manufactured by Mitsubishi Chemical. This measurement was performed under the conditions of 2.0 kg in load, 10 s in charging time, and 10 V or 250 V in applied voltage.

Table 2 clearly shows that a high coverage leads to space saving and that AC charging of the transport belt 3 at a frequency in a predetermined range enhances transport adsorption. The present inventors have further found that, in a recording apparatus having the structure as in the above embodiment, suitable transport adsorption can be imparted by electrically charging the outer layer O with an AC current with a frequency in the range of 10 Hz to 200 Hz. It has been also found that more suitable transport adsorption can be achieved at a frequency of 20 Hz to 100 Hz, preferably 40 Hz to 60 Hz.

What is claimed is:

1. A recording apparatus comprising:
an endless transport belt including an inner layer and an outer layer having a supporting surface on which a recording medium is supported, the outer layer containing a hydrophobic material;
AC charging device that electrically charges the supporting surface of the transport belt at a frequency in the range of 10 Hz to 200 Hz to enable the supporting surface to electrostatically adsorb the recording medium;
a line head having a nozzle through which an ink is ejected onto the recording medium transported with being electrostatically adsorbed to the supporting surface; and
a member disposed in a region opposing the supporting surface,
wherein while the ink is ejected onto the recording medium, the distance between the supporting surface and the member is larger than the distance between the nozzle of the line head and the supporting surface.

2. The recording apparatus according to claim 1, wherein the transport belt is capable of transporting the recording medium electrostatically adsorbed thereto at a relative humidity of 70% or more.

3. The recording apparatus according to claim 1, wherein the outer layer has a surface resistivity of 10¹⁰ Ω/sq. or more, and the inner layer has a volume resistivity in the range of 10⁵ Ω·cm to less than 10¹⁰ Ω·cm.

4. The recording apparatus according to claim 1, wherein the distance between the nozzle and the supporting surface of the transport belt is 5 mm or less.

5. The recording apparatus according to claim 1, wherein the ink contains 20% to 75% by mass of water.

6. The recording apparatus according to claim 1, wherein the member covers 60% or more of the supporting surface of the transport belt when viewed from above in a path through which the recording medium is transported.

7. The recording apparatus according to claim 1, wherein the member is at least one of a capping unit that comes in contact with the line head so as to cover the nozzle and define a closed space with the line head or a wiping unit that wipes a surface having the nozzle of the line head.

8. The recording apparatus according to claim 7, further comprising a transfer mechanism that transfers the line head so as to come close to and separate from the supporting surface of the transport belt, wherein the member includes the capping unit that caps the line head, and wherein the distance between the capping unit and the supporting surface while the capping unit caps the line head is larger than the distance between the nozzle and the supporting surface while the ink is ejected onto the recording medium.

9. The recording apparatus according to claim 1, further comprising a tension adjusting mechanism capable of adjusting the tension on the transport belt so that, when recording is not performed, the transport belt has a lower tension than the tension during recording.

10. The recording apparatus according to claim 1, wherein the transport belt transports the recording medium at a speed of 8 inches per second or more.

11. A recording apparatus comprising:
an endless transport belt including an inner layer and an outer layer having a supporting surface on which a recording medium is supported, the outer layer containing a hydrophobic material;
an AC charging device that electrically charges the supporting surface of the transport belt to enable the supporting surface to electrostatically adsorb the recording medium, by alternately applying a positive charge and a negative charge to the outer layer at intervals of 3 mm to mm in a direction in which the recording medium is transported;
a line head having a nozzle through which an ink is ejected onto the recording medium transported with being electrostatically adsorbed to the supporting surface; and
a member disposed in a region opposing the supporting surface,
wherein while the ink is ejected onto the recording medium, the distance between the member and the supporting surface is larger than the distance between the nozzle of the line head and the supporting surface.
